(19) United States
(12) Patent Application Publication
(10) Pub. No.: US 2020/0142254 A1
(43) Pub. Date: May 7, 2020

(54) IMAGING DEVICE

(71) Applicant: Samsung Electronics Co., Ltd., Suwon-si, Gyeonggi-do (KR)

(72) Inventors: Jae Yeol RYU, Moscow (RU); Nikolay Victorovich MURAVEV, Podolsk (RU); Dmitriy Evgenyevich PISKUNOV, Pushkinskiy Rayon (RU); Mikhail Vyacheslavovich POPOV, Krasnogorsk (RU); Andrey Nikolaevich PUTILIN, Moscow (RU); Andrey Alexandrovich MANKO, Moscow (RU); Aleksander Victorovich MOROZOV, Podolskiy distr. (RU)

(21) Appl. No.: 16/613,877

(22) PCT Filed: Apr. 26, 2018
(86) PCT No.: PCT/KR2018/004829

§ 371 Date: Nov. 15, 2019

(30) Foreign Application Priority Data
May 15, 2017 (RU) 2017116812
Feb. 9, 2018 (KR) 10-2018-0016574

(51) Int. Cl. G02F 1/1335; G02F 1/13363

(52) U.S. Cl. CPC G02F 1/133528; G02F 1/13363; G02F 2001/133633; G02F 2001/133548; G02F 2001/133638; G02F 1/133526

(57) ABSTRACT

An imaging device is provided. The imaging device includes: a display which emits light indicating a predetermined image; a first polarizer which is disposed in front of the display and polarizes the light to a first linearly polarized state; a first retarder which is disposed in front of the first polarizer and changes the first linearly polarized state of the light to a first circularly polarized state; a first optical element which includes a cholesteric liquid crystal layer and passes therethrough the light of the first circularly polarized state, which is incident after passing through the first retarder; a second retarder which is disposed in front of the first optical element and changes the first circularly polarized state of the light to a second linearly polarized state; and a second optical element which reflects the light incident in the second linearly polarized state to the first optical element through the second retarder such that the second linearly polarized state of the light is changed to a second circularly polarized state.

### CROSS-REFERENCE TO RELATED APPLICATIONS

This application is a 371 National Stage of International Application No. PCT/KR2018/004829, filed Apr. 26, 2018, which claims priority to Russian Patent Application No. 2017116812, filed May 15, 2017, and Korean Patent Application No. 10-2018-0016574, filed Feb. 9, 2018, the disclosures of which are herein incorporated by reference in their entirety.

### BACKGROUND

### 1. Field

The disclosure relates to an imaging technical field and, more particularly, to an imaging device capable of generating a high-quality image.

### 2. Description of Related Art

High-resolution imaging devices have been frequently getting used for various purposes, particularly, virtual reality (VR) applications. The development and improvement of VR devices have suggested new possibilities to users in various fields. For example, a user with a VR helmet or VR glasses may be easily and quickly immersed in a desired VR environment and, for example, simulate various situations even while actually sitting at home. Using this VR environment in the video game industry is well known, but this environment may be very well applied to all other industry fields.

Particularly, a VR device is generally used as follows:
in the military for a battlefield, combat situation, or medical training;
in an education industry for e-learning;
in a medical field for VR diagnosis and virtual robot surgery;
in a business community for virtual travel and education; and
in a communication field for video conference and telemedicine.

It is preferable or essential for the application examples listed above that a VR device is mounted on a head such that the hands of a wearer may move freely and easily to hold a necessary object, e.g., a gun in a battlefield of a combat situation. In addition, the mobility of the wearer is influenced by its own weight and size of the VR device. To solve this problem, various attempts have been made, but some of the attempts are to make optical elements included in a VR element thin by replacing an existing optical mirror with a liquid crystal film, a thin-film polarizer, or the like and reducing the number of optical elements. However, the less the number of optical elements, the shorter an optical path in a total system, and thus, the attempts need to be careful because image quality may be degraded.

U.S. Pat. No. 5,853,240 discloses a small and light liquid crystal projector combined with a head mounted display (HMD) to an image or a three-dimensional (3D) image from the HMD to a common screen. The HMD has, in a casing thereof, an optical device for enlarging an image of a liquid crystal panel illuminated by a backlight. The optical device includes: a refractive element coated with a half-mirror; and a cholesteric liquid crystal element acting as a circularly-polarized-light selecting translucent mirror. The solution of this related art still uses a translucent mirror (i.e., a half-mirror), and thus a total size and weight of a total system are not significantly reduced.

U.S. Pat. No. 6,094,242 discloses an optical HMD device including a refractor consisting of a refractive element coated with a half-mirror and a circularly-polarized-light selecting translucent mirror, which are disposed in order from a light incident side. The translucent mirror consists of a quarter-wave plate (phase difference plate), a half-mirror and a polarizer or cholesteric liquid crystal, which are disposed in order from the light incident side. A thin and high-magnification optical system is obtained by using the circularly-polarized-light selecting-translucent mirror which first reflects incident light in a clockwise circularly polarized fashion and allows the counterclockwise circularly polarized light having made 1.5 round trips to pass therethrough without being reflected. However, this solution of the related art cannot be used for light beams of both linear and circularly polarized lights, and thus available application fields are reduced.

U.S. Pat. No. 6,866,194 discloses a display device including an ocular optical system which has a cholesteric liquid crystal for displaying a planar image, a fiber plate for converting the displayed planar image into a spherical image, and first and second spherical translucent reflective surfaces and projects a spherical image. However, the solution of this related art cannot provide the possibility that light beams of both linear light and circularly polarized light are used. In addition, a result image always shows a spherical image.

Therefore, an imaging device, which has a low weight and a small volume, capable of generating a high-quality image and simultaneously operating for light beams of two different polarized states is necessary. It is further preferable that the imaging device is a head mounting type and is applied to a VR application.

### SUMMARY

An embodiment of the disclosure provides an imaging device having a low weight and a small volume.

According to an embodiment of the disclosure, there is provided an imaging device including: a display which emits light indicating a predetermined image; a first polarizer which is disposed in front of the display and polarizes the light to a first linearly polarized state; a first retarder which is disposed in front of the first polarizer and changes the first linearly polarized state of the light to a first circularly polarized state; a first optical element which passes therethrough the light of the first circularly polarized state, which is incident after passing through the first retarder; a second retarder which is disposed in front of the first optical element and changes the first circularly polarized state of the light to a second linearly polarized state; and a second optical element which reflects the light incident in the second linearly polarized state to the first optical element through the second retarder such that the second linearly polarized state of the light is changed to a second circularly polarized state, wherein the first optical element re-reflects the light of the second circularly polarized state to the second optical element through the second retarder such that the second circularly polarized state is changed to the first linearly polarized state.

The second optical element may deliver the light of the first linearly polarized state to the eyes of a user.

The first optical element may include a cholesteric liquid crystal layer, and according to alignment of liquid crystal molecules in the cholesteric liquid crystal layer, the light of the first circularly polarized state may pass through the first optical element, or the light of the second circularly polarized state may be changed to the first linearly polarized state.

The first optical element may include at least one of a lens and an optical film, and the cholesteric liquid crystal layer may be disposed on the surface of the lens or the optical film or embedded in the lens or the optical film.

The lens or the optical film may be formed of an optically transparent material selected from one of optical glass, an optical crystal, and a polymer.

The second optical element may include a second polarizer.

The second polarizer may be a wire grid polarizer.

The wire grid polarizer may consist of parallel metal wire layers formed on the surface of the second optical element.

At least one of the first retarder and the second retarder may be a λ/4 retarder.

The first retarder may include a switchable λ/4 retarder including a liquid crystal layer sandwiched between two electrical contact layers, and the imaging device may operate in a first mode and a second mode, which are different modes.

In the first mode, the display may be turned on and emit light, and liquid crystal molecules of the liquid crystal layer in the switchable λ/4 retarder may be aligned to change the light of the first linearly polarized state to the first circularly polarized state, and in the second mode, the transparent display may be turned off, and the liquid crystal molecules in the switchable λ/4 retarder may be aligned such that ambient light, which has passed through the transparent display, is delivered to the eyes of the user without being reflected.

The imaging device may be switched to the first mode in response to a predetermined voltage applied between the electrical contact layers and switched to the second mode when no voltage is applied between the electrical contact layers.

The imaging device may be switched to the first mode and the second mode at a switching frequency of 120 Hz or more.

The display may include at least one of a liquid crystal display (LCD), a light-emitting diode (LED) display, an organic LED (OLED) display, or a laser diode display.

The first polarizer may be a thin-film polarizer.

The imaging device may be integrated in at least one of a virtual reality device, an augmented reality device, or an optical system.

According to another embodiment, there is provided an imaging device including: a display which emits light indicating a predetermined image; a first polarizer which is disposed in front of the display and polarizes the light to a first linearly polarized state; a first optical element which passes therethrough the light incident in the first linearly polarized state; a retarder which is disposed in front of the first optical element and changes the light of the first linearly polarized state to a first circularly polarized state; and a second optical element which reflects the light of the first circularly polarized state to the first optical element through the retarder such that the first circularly polarized state of the light is changed to a second linearly polarized state, wherein the first optical element re-reflects the light of the second linearly polarized state to the second optical element through the second retarder such that the second linearly polarized state is changed to a second circularly polarized state.

The second optical element may deliver the light of the second circularly polarized state to the eyes of a user.

The first optical element may include a wire grid polarizer.

The second optical element may include a cholesteric liquid crystal layer, and according to alignment of liquid crystal molecules in the cholesteric liquid crystal layer, the light of the first circularly polarized state may be changed to the second circularly polarized state.

### BRIEF DESCRIPTION OF THE DRAWINGS

FIG. 1 illustrates an imaging device according to an embodiment of the disclosure.

FIG. 2 illustrates an optical element included in the imaging device of FIG. 1 and other optical elements.

FIGS. 3 and 4 illustrate a switching element for the imaging device of FIG. 1.

FIG. 5 illustrates an imaging device according to another embodiment of the disclosure.

### DETAILED DESCRIPTION

Various embodiments of the disclosure will be described in more detail with reference to the accompanying drawings. However, the disclosure may be implemented by other many forms, and it should not be understood that the disclosure is limited to arbitrary specific structures or functions described below. On the contrary, these embodiments are provided to clearly and fully describe the disclosure. According to the description of the disclosure, it would be obvious that a scope of the disclosure involves arbitrary embodiments of the disclosure, which are described in the present specification, regardless of whether the embodiments are implemented independently or together with other arbitrary embodiments. For example, the devices disclosed in the specification, may be actually implemented by using an arbitrary number of embodiments provided in the present specification. In addition, it should be understood that an arbitrary embodiment of the disclosure may be implemented by using one or more elements provided in the attached claims.

In the present specification, the term “illustrative” is used as the meaning of “used as an example or an illustration”. In the present specification, an arbitrary embodiment described to be “illustrative” should not be analyzed to be necessarily preferable or to have more advantageous than another embodiment.

In the present specification, the term “cholesteric liquid crystal” is used as general meaning and indicates a liquid crystal having a spiral structure and a chiral property. Cholesteric liquid crystals are also known as chiral nematic liquid crystals. These crystals are formed as a layer without aligning positions thereof in the layer Due to a periodic structure (i.e., spiral molecule alignment), the cholesteric liquid crystals selectively reflect light components in a given wavelength. In the disclosure, it is essential that the cholesteric liquid crystals maximally passing therethrough light beams of first circularly polarized light and maximally reflecting light beams of second circularly polarized light may be used.

In the disclosure, the term “polarizer” is used as general meaning and indicates an optical filter capable of passing therethrough light beams of one polarized state and blocking light beams of the other polarized states. The polarizer may be generally classified into a linear polarizer and a circular polarizer. A wire grid polarizer described herein is one of the simplest linear polarizers and may consist of several fine parallel metallic wires arranged on a specific plane. In summary, this configuration of the wire grid polarizer allows light to pass therethrough in a linearly polarized state.

In the disclosure, the term “retarder” (or “wavelength plate”) is used as general meaning and indicates an optical device capable of changing a polarized state of light passing through the retarder. One type of retarder used in an example embodiment of the disclosure indicates a λ/4 retarder. The λ/4 retarder is configured to change linearly polarized light to circularly polarized light or vice versa.

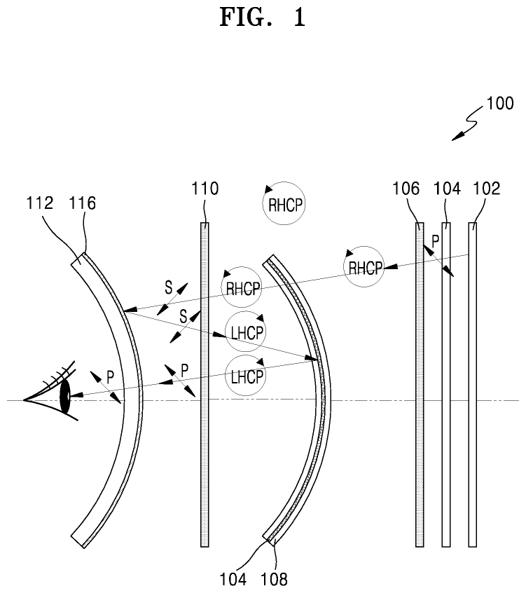

FIG. 1 illustrates an imaging device 100 according to an embodiment of the disclosure. As shown in FIG. 1, the imaging device 100 includes a display 102, a first polarizer 104, a first retarder 106, a first optical element 108, a second retarder 110, and a second optical element 112. The imaging device 100 will be described below in detail.

The display 102 emits light indicating a predetermined image. The display 102 may be any one of commercially usable displays used in conventional electronic devices, for example, a liquid crystal display (LCD), a light-emitting diode (LED) display, an organic LED (OLED) display, or a laser diode display. As obvious to those of ordinary skill in the art, each display type is selected depending on a specific application.

The first polarizer 104 is disposed in front of the display 102 and polarizes the light from the display 102 to a first linearly polarized state, i.e., p-polarization (short p-state). The first linearly polarized state is schematically shown in FIG. 1 with both-end arrows inclined to the left. According to an example embodiment, the first polarizer 104 may be a thin-film polarizer to reduce a total volume of the imaging device 100. Types of the thin-film polarizer are well known in a corresponding technical field, and thus, they are not described herein.

The first retarder 106 is disposed in front of the first polarizer 104 and changes the p-state of the light to a first circularly polarized state. The first circularly polarized state is a right-hand circularly polarized (RHCP) state (i.e., clockwise polarized state) and is schematically shown in FIG. 1. According to an example embodiment, the first retarder 106 is a λ/4 retarder and the λ/4 retarder is well known in the corresponding technical field.

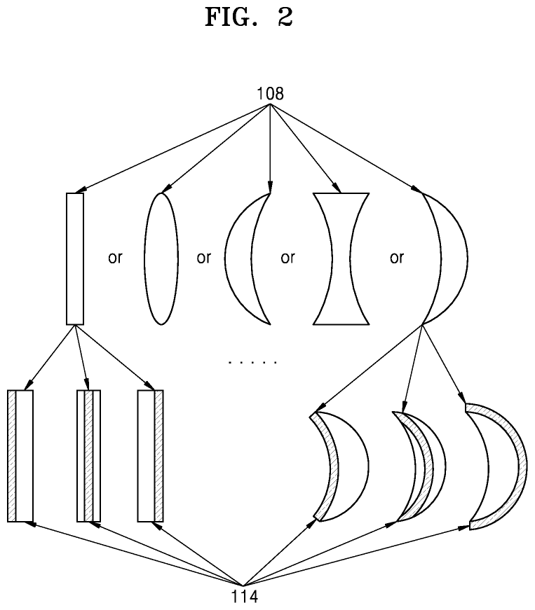

The first optical element 108 is disposed in front of the first retarder 106 and has a cholesteric liquid crystal layer 114 embedded therein. Liquid crystal molecules in the cholesteric liquid crystal layer 114 are aligned to pass therethrough the light of the RHCP state, which is incident to the cholesteric liquid crystal layer 114 after passing through the first retarder 106. According to some other embodiments, the cholesteric liquid crystal layer 114 may be deposited on one surface of the first optical element 108 as shown in FIG. 2. Another implementation example of the first optical element 108 is shown in FIG. 2 as a lens or film design. Particularly, each of the first optical element 108 and the second optical element 112 may be a convex lens, a concave lens, a concave-convex lens, a convex-concave lens, a biconvex lens, a biconcave lens, a plano-convex lens, a plano-concave lens, a spherical lens, or an aspherical lens. In addition, the lens or film described above may be made of an optically transparent material including optical glass, an optical crystal, and a polymer.

The second retarder 110 is disposed in front of the first optical element 108 and changes the RHCP state of the light to a second linearly polarized state, i.e., s-polarization (short s-state). The second linearly polarized state is schematically shown in FIG. 1 with both-end arrows inclined to the right. According to an example embodiment, the second retarder 110 may be λ/4 retarder similar to the first retarder 106.

The second optical element 112 is disposed in front of the second retarder 110 and has a wire grid polarizer 116 disposed thereon (according to another embodiment, the wire grid polarizer 116 may be embedded in the second optical element 112 similarly to the cholesteric liquid crystal layer 114). The wire grid polarizer 116 reflects the light incident in the s-state to the first optical element 108 (i.e., the cholesteric liquid crystal layer 114) through the second retarder 110 such that the s-state of the light is changed to the second circularly polarized state. The second circularly polarized state is a left-hand circularly polarized (LHCP) state (i.e., counterclockwise polarized state) and is schematically shown in FIG. 1. The above-described liquid crystal molecules in the cholesteric liquid crystal layer 114 may be aligned to re-reflect the light of the LHCP state to the second optical element 112 through the second retarder 110 such that the LHCP state is changed to the p-state. The wire grid polarizer 116 delivers the light of the p-state to the eyes of a user.

Although an alignment state of light passing through the imaging device 100 has been described above, it would be obvious to those of ordinary skill in the art that the alignment state is not limited to FIG. 1. According to another embodiment, for example, the LHCP state may occur after light passes through the first retarder 106, and the RHCP state may occur after light passes through the second retarder 110. That is, the first and second retarders 106 and 110 may be interchangeably used. The same manner is also applied to the p-state and the s-state. For example, the first polarizer 104 may polarize light from the display 102 to the s-state (instead of the p-state). Accordingly, the second retarder 110 may change circular polarization (i.e., an RHCP or LHCP state) of the light incident thereon to the p-state (instead of the s-state as shown in FIG. 1).

A technique of forming the cholesteric liquid crystal layer 114 and the wire grid polarizer 116 is well known to those of ordinary skill in the art. For example, a process of filling liquid crystals in a precursor of which one surface or both surfaces are exposed, by using a vacuum method or a capillary effect, may be used as a process of forming a cholesteric liquid crystal layer, and a nano-imprint lithography, laser interference lithography, or soft lithography process may be used to form a wire grid polarizer.

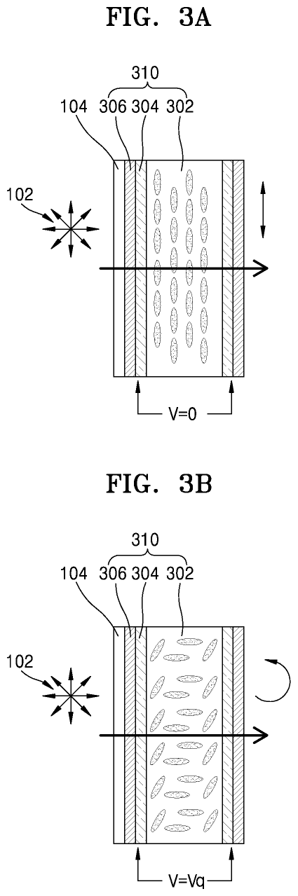

FIGS. 3 and 4 illustrate different embodiments. In FIGS. 3 and 4, the display 102 may be implemented by a transparent display (not shown), and the first retarder 106 may be implemented by a switchable λ/4 retarder 310 including a liquid crystal layer 302 sandwiched between two electrical contact layers 304 (sequentially deposited on a substrate 306). With this configuration, the imaging device 100 may operate in a first mode and a second mode. In the first mode, the transparent display is turned on and emits light, and liquid crystal molecules in the switchable λ/4 retarder 310 change a linearly polarized state (i.e., the p-state or the s-state) to a circularly polarized state (i.e., the LHCP or RHCP state). In the second mode, the transparent display is turned off, and the liquid crystal molecules in the switchable λ/4 retarder 310 are aligned to deliver ambient light passing through the transparent display to the eyes of the user without reflection. The electrical contact layer 304 may be made of indium tin oxide (ITO). In addition, the imaging device 100 may be configured to be switched to the second mode when no voltage is applied between the electrical contact layers 304 (FIG. 3) and to the first mode in response to a predetermined voltage Vq applied between the electrical contact layers 304 (FIG. 4). The imaging device 100 may be configured to be switched to the first mode and the second mode at a switching frequency of 120 Hz or more. This switching configuration allows the user to alternately view an ambient scene and an image displayed on the display 102 at the switching frequency described above.

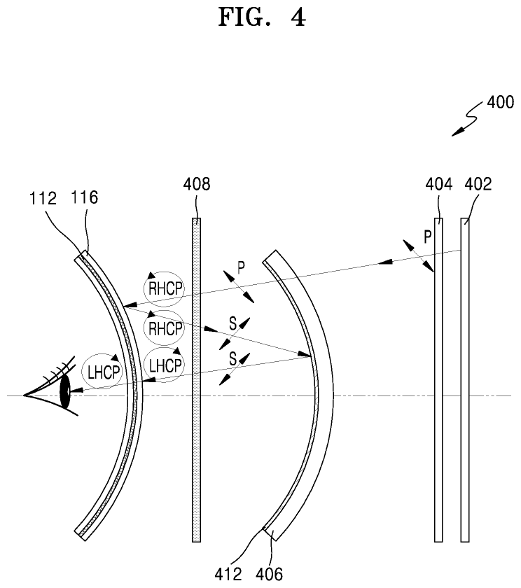

FIG. 5 illustrates an imaging device 400 according to another embodiment of the disclosure. The imaging device 400 has a different number of components and a different arrangement as compared to the imaging device 100 of FIG. 1. Particularly, the imaging device 400 includes a display 402, a first polarizer 404, a first optical element 406, a retarder 408, and a second optical element 410. The display 402 emits light indicating a predetermined image. The first polarizer 404 is disposed in front of the display 402 and polarizes the light to the first linearly polarized state (i.e., the p-state). The first optical element 406 includes a second polarizer 412 formed thereon. The second polarizer 412 may be a wire grid polarizer configured to pass therethrough incident light in the p-state. The retarder 408 is disposed in front of the first optical element 406 and changes the p-state of the light to the first circularly polarized state (i.e., the RHCP state). The second optical element 410 includes a cholesteric liquid crystal layer 414 embedded therein (if necessary, the cholesteric liquid crystal layer 414 may be deposited on one of the surfaces of the second optical element 410). Liquid crystal molecules in the cholesteric liquid crystal layer 414 are aligned to reflect the light of the RHCP state, which is incident to the cholesteric liquid crystal layer 414, to the first optical element 406 through the retarder 408, such that the RHCP state of the light is changed to the second linearly polarized state (i.e., the s-state). In addition, the wire grid polarizer 412 re-reflects the light of the s-state to the second optical element 410 through the retarder 408 such that the s-state to the light is changed to the second circularly polarized state (i.e., the LHCP state). Alignment of the molecules of cholesteric liquid crystals allows the light of the LHCP state to be delivered to the eyes of the user.

The disclosure may be applied to cases where a user needs to be immersed in virtual reality in order to perform various works such as three-dimensional (3D) modeling, games, navigation, and designs. In addition, the disclosure may also be applied to various head-mounted devices such as glasses or helmets which are widely used in game devices and education industries at present. The disclosure may also be applied to various optical systems such as a projector, a collimator, a telescope, binoculars, a range finder, and a 3D scanner.

Another aspect of the disclosure will be clear by considering the drawings and the above description of the embodiments of the disclosure. Those of ordinary skill in the art will recognize that other embodiments of the disclosure are possible and details of the disclosure may be modified in various aspects without departing from the concept of the disclosure. Therefore, it should be considered that the drawings and the description are intrinsically illustrative and not for purpose of limitation. An element mentioned in a singular form in the attached claims does not exclude the existence of the element in the plural unless there is different disclosure.

1. An imaging device comprising:
a display which emits light indicating a predetermined image;
a first polarizer which is disposed in front of the display and polarizes the light to a first linearly polarized state;
a first retarder which is disposed in front of the first polarizer and changes the first linearly polarized state of the light to a first circularly polarized state;
a first optical element which passes therethrough the light of the first circularly polarized state, which is incident after passing through the first retarder;
a second retarder which is disposed in front of the first optical element and changes the first circularly polarized state of the light to a second linearly polarized state; and
a second optical element which reflects the light incident in the second linearly polarized state to the first optical element through the second retarder such that the second linearly polarized state of the light is changed to a second circularly polarized state,
wherein the first optical element re-reflects the light of the second circularly polarized state to the second optical element through the second retarder such that the second circularly polarized state is changed to the first linearly polarized state.

2. The imaging device of claim 1, wherein the second optical element delivers the light of the first linearly polarized state to the eyes of a user.

3. The imaging device of claim 1, wherein the first optical element comprises a cholesteric liquid crystal layer, and according to alignment of liquid crystal molecules in the cholesteric liquid crystal layer, the light of the first circularly polarized state passes through the first optical element, or the light of the second circularly polarized state is changed to the first linearly polarized state.

4. The imaging device of claim 3, wherein
the first optical element comprises at least one of a lens and an optical film, and
the cholesteric liquid crystal layer is disposed on the surface of the lens or the optical film or embedded in the lens or the optical film.

5. The imaging device of claim 4, wherein the lens or the optical film is formed of an optically transparent material selected from one of optical glass, an optical crystal, and a polymer.

6. The imaging device of claim 1, wherein the second optical element comprises a second polarizer.

7. The imaging device of claim 6, wherein the second polarizer is a wire grid polarizer.

8. The imaging device of claim 7, wherein the wire grid polarizer is made of a parallel metal wire layer formed on the surface of the second optical element.

9. The imaging device of claim 1, wherein at least one of the first retarder and the second retarder is a λ/4 retarder.

10. The imaging device of claim 1, wherein
the first retarder comprises a switchable λ/4 retarder including a liquid crystal layer sandwiched between two electrical contact layers, and
the imaging device operates in a first mode and a second mode which are different modes.

11. The imaging device of claim 10, wherein,
in the first mode, the display is turned on and emits the light, and liquid crystal molecules of the liquid crystal layer in the switchable λ/4 retarder are aligned to change the light of the first linearly polarized state to the first circularly polarized state, and
in the second mode, the transparent display is turned off, and the liquid crystal molecules in the switchable λ/4 retarder are aligned such that ambient light which has passed through the transparent display is delivered to the eyes of a user without being reflected.

12. The imaging device of claim 10, wherein the imaging device is switched to the first mode in response to a predetermined voltage applied between the electrical contact layers and switched to the second mode when no voltage is applied between the electrical contact layers.

13. The imaging device of claim 10, wherein the imaging device is switched to the first mode and the second mode at a switching frequency of 120 Hz or more.

14. The imaging device of claim 1, wherein the display comprises at least one of a liquid crystal display (LCD), a light-emitting diode (LED) display, an organic LED (OLED) display, or a laser diode display.

15. The imaging device of claim 1, wherein the first polarizer is a thin-film polarizer.
